(19) United States
(12) Patent Application Publication
(10) Pub. No.: US 2023/0163887 A1
(43) Pub. Date: May 25, 2023

(54) USER EQUIPMENT AND METHOD FOR HANDLING HARQ-ACK FEEDBACK

(71) Applicant: FG Innovation Company Limited, Tuen Mun (HK)

(72) Inventors: CHIEN-CHUN CHENG, Taipei (TW); CHIA-HAO YU, Taipei (TW)

(21) Appl. No.: 17/919,381

(22) PCT Filed: Apr. 20, 2021
(86) PCT No.: PCT/CN2021/088396

§ 371 Date: Oct. 17, 2022

Related U.S. Application Data
(60) Provisional application No. 63/012,881, filed on Apr. 20, 2020.
(60) Provisional application No. 63/012,887, filed on Apr. 20, 2020.

(51) Int. Cl. H04L 1/1812; H04W 72/1273; H04W 72/23

(52) U.S. Cl. CPC H04L 1/1812; H04W 72/1273; H04W 72/23; H04W 84/06

(57) ABSTRACT

A user equipment (UE) and method for handling hybrid automatic repeat request (HARQ)-acknowledgment (ACK) feedback are provided. The method includes receiving, from a base station (BS), a parameter for disabling a HARQ-ACK feedback for a HARQ process identifier (ID); receiving, from the BS, downlink control information (DCI) for scheduling a physical downlink shared channel (PDSCH), the DCI indicating the HARQ process ID; setting a HARQ-ACK bit associated with the HARQ process ID to a bit value representing a negative acknowledgment (NACK); and transmitting, to the BS, a HARQ-ACK codebook including the HARQ-ACK bit.

### CROSS-REFERENCE TO RELATED APPLICATION(S)

The present disclosure claims the benefit of and priority of provisional U.S. Patent Application Ser. No. 63/012,881, filed on Apr. 20, 2020, entitled “TIMING RELATIONSHIP ENHANCEMENTS FOR TYPE-1 HARQ-ACK CODEBOOK IN NTN” (“the '881 provisional”) and provisional U.S. Patent Application Ser. No. 63/012,887, filed on Apr. 20, 2020, entitled “UPLINK POWER CONTROL FOR TYPE-1 HARQ-ACK CODEBOOK IN NTN” (“the '887 provisional”). The disclosure of the '881 provisional and the disclosure of the '887 provisional are hereby incorporated fully by reference into the present disclosure for all purposes.

### FIELD

The present disclosure is generally related to wireless communication, and, more specifically, to a method for handling hybrid automatic repeat request (HARQ)-acknowledgment (ACK) feedback for the next generation wireless communication networks.

### BACKGROUND

With the tremendous growth in the number of connected devices and the rapid increase in user/network traffic volume, various efforts have been made to improve different aspects of wireless communication for cellular wireless communication systems, such as fifth-generation (5G) New Radio (NR), by improving data rate, latency, reliability and mobility. The 5G NR system is designed to provide flexibility and configurability to optimize the network services and types, accommodating various use cases such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art.

### SUMMARY

The present disclosure is directed to a method for handling HARQ-ACK feedback for the next-generation wireless communication networks.

According to an aspect of the present disclosure, a method for handling HARQ-ACK feedback performed by a user equipment (UE) is provided. The method includes receiving, from a base station (BS), a parameter that disables a HARQ-ACK feedback for a HARQ process identifier (ID); receiving, from the BS, downlink control information (DCI) that schedules a physical downlink shared channel (PDSCH), the DCI indicating the HARQ process ID; setting a HARQ-ACK bit associated with the HARQ process ID to ‘NACK’; and transmitting, to the BS, a HARQ-ACK codebook including the HARQ-ACK bit.

According to another aspect of the present disclosure, a UE is provided that includes a processor and a memory coupled to the processor, wherein the memory stores a computer-executable program that when executed by the processor, causes the processor to receive, from a BS, a parameter that disables a HARQ-ACK feedback for a HARQ process ID; receive, from the BS, DCI that schedules a PDSCH, the DCI indicating the HARQ process ID; set a HARQ-ACK bit associated with the HARQ process ID to ‘NACK’; and transmit, to the BS, a HARQ-ACK codebook including the HARQ-ACK bit.

### BRIEF DESCRIPTION OF THE DRAWINGS

Aspects of the present disclosure are best understood from the following detailed description when read with the accompanying figures. Various features are not drawn to scale. Dimensions of various features may be arbitrarily increased or reduced for clarity of discussion.

FIG. 1 illustrates an NTN network with an LEO satellite of transparent payload according to an implementation of the present disclosure.

FIG. 2 illustrates a scenario in which the UL SCS is greater than the DL SCS according to an implementation of the present disclosure.

FIG. 3 illustrates a scenario in which the DL SCS is greater than the UL SCS according to an implementation of the present disclosure.

FIG. 4 illustrates a process of an active DL BWP change according to an implementation of the present disclosure.

FIG. 5 illustrates a process of an active UL BWP change according to an implementation of the present disclosure.

FIG. 6 illustrates a process of receiving TDD frame configuration according to an implementation of the present disclosure.

FIG. 7 illustrates a method for handling HARQ-ACK feedback performed by a UE according to an implementation of the present disclosure.

FIG. 8 is a block diagram illustrating a node for wireless communication according to an implementation of the present disclosure.

### DESCRIPTION

The following contains specific information related to example implementations of the present disclosure. The drawings and their accompanying detailed description are merely directed to example implementations. However, the present disclosure is not limited to these example implementations. Other variations and implementations of the present disclosure will be obvious to those skilled in the art.

Unless noted otherwise, like or corresponding elements among the drawings may be indicated by like or corresponding reference designators. Moreover, the drawings in the present disclosure are generally not to scale, and are not intended to correspond to actual relative dimensions.

For the purpose of consistency and ease of understanding, like features may be identified (although, in some examples, not illustrated) by the same reference designators in the drawings. However, the features in different implementations may differ in other respects and shall not be narrowly confined to the implementations illustrated in the drawings.

The phrases “in one implementation,” or “in some implementations,” may each refer to one or more of the same or different implementations. The term “coupled” is defined as connected whether directly or indirectly via intervening components and is not necessarily limited to physical connections. The term “comprising” means “including, but not necessarily limited to” and specifically indicates open-ended inclusion or membership in the disclosed combination, group, series or equivalent. The expression “at least one of A, B and C” or “at least one of the following: A, B and C” means “only A, or only B, or only C, or any combination of A, B and C.”

The terms “system” and “network” may be used interchangeably. The term “and/or” is only an association relationship for disclosing associated objects and represents that three relationships may exist such that A and/or B may indicate that A exists alone, A and B exist at the same time, or B exists alone. “A and/or B and/or C” may represent that at least one of A, B, and C exists. The character “/” generally represents that the associated objects are in an “or” relationship.

For the purposes of explanation and non-limitation, specific details, such as functional entities, techniques, protocols, standards, and the like, are set forth for providing an understanding of the disclosed technology. In other examples, detailed disclosure of well-known methods, technologies, systems, architectures, and the like are omitted so as not to obscure the present disclosure with unnecessary details.

Persons skilled in the art will immediately recognize that any disclosed network function(s) or algorithm(s) may be implemented by hardware, software or a combination of software and hardware. Disclosed functions may correspond to modules which may be software, hardware, firmware, or any combination thereof.

A software implementation may include computer-executable instructions stored on a computer-readable medium such as memory or other types of storage devices. One or more microprocessors or general-purpose computers with communication processing capability may be programmed with corresponding executable instructions and perform the disclosed network function(s) or algorithm(s).

The microprocessors or general-purpose computers may include Applications Specific Integrated Circuitry (ASIC), programmable logic arrays, and/or using one or more Digital Signal Processors (DSPs). Although some of the disclosed implementations are oriented to software installed and executing on computer hardware, alternative example implementations implemented as firmware or as hardware or as a combination of hardware and software are well within the scope of the present disclosure.

The computer-readable medium may include, but is not limited to, Random Access Memory (RAM), Read-Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) may typically include at least one Base Station (BS), at least one UE, and one or more optional network elements that provide connection within a network. The UE may communicate with the network such as a Core Network (CN), an Evolved Packet Core (EPC) network, an Evolved Universal Terrestrial Radio Access Network (E-UTRAN), a Next-Generation Core (NGC), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE may be configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM that is often referred to as 2G), GSM Enhanced Data rates for GSM Evolution (EDGE) Radio Access Network (GERAN), General Packet Radio Service (GPRS), Universal Mobile Telecommunication System (UMTS that is often referred to as 3G) based on basic Wideband-Code Division Multiple Access (W-CDMA), High-Speed Packet Access (HSPA), LTE, LTE-A, evolved/enhanced LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a Radio Network Controller (RNC) in UMTS, a Base Station Controller (BSC) in the GSM/GERAN, a next-generation eNB (ng-eNB) in an Evolved Universal Terrestrial Radio Access (E-UTRA) BS in connection with 5GC, a next-generation Node B (gNB) in the 5G RAN (or in the 5G Access Network (5G-AN)), or any other apparatus capable of controlling radio communication and managing radio resources within a cell. The BS may serve one or more UEs via a radio interface.

The BS may be operable to provide radio coverage to a specific geographical area using a plurality of cells included in the RAN. The BS may support the operations of the cells. Each cell may be operable to provide services to at least one UE within its radio coverage.

Each cell (often referred to as a serving cell) may provide services to serve one or more UEs within its radio coverage such that each cell schedules the downlink (DL) and optionally UL resources to at least one UE within its radio coverage for DL and optionally UL packet transmissions. The BS may communicate with one or more UEs in the radio communication system via the plurality of cells.

A cell may allocate Sidelink (SL) resources for supporting Proximity Service (ProSe), LTE SL services, and/or LTE/NR Vehicle-to-Everything (V2X) service. Each cell may have overlapped coverage areas with other cells. In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), comprising of the SpCell and optionally one or more Secondary Cells (SCells). An SCG may refer to a group of serving cells associated with the Secondary Node (SN), comprising of the SpCell and optionally one or more SCells.

As disclosed previously, the frame structure for NR supports flexible configurations for accommodating various next-generation (e.g., 5G) communication requirements such as enhanced mobile broadband (eMBB), massive machine type communication (mMTC), and ultra reliable and low latency communication (URLLC), while fulfilling high reliability, high data rate and low latency requirements. The Orthogonal Frequency-Division Multiplexing (OFDM) technology in the 3^{rd} Generation Partnership Project (3GPP) may serve as a baseline for an NR waveform. The scalable OFDM numerology such as adaptive sub-carrier spacing, channel bandwidth, and Cyclic Prefix (CP) may also be used.

Two coding schemes are considered for NR: specifically Low-Density Parity-Check (LDPC) code and Polar Code. The coding scheme adaption may be configured based on channel conditions and/or service applications.

At least DL transmission data, a guard period, and an UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Example description of some selected terms used in this disclosure are given below.

Cell: Radio network object that can be uniquely identified by a UE from a (cell) identification that is broadcasted over a geographical area from one UTRAN Access Point. A Cell is either FDD or TDD mode.

Serving Cell: For a UE in Radio Resource Control (RRC)_CONNECTED not configured with carrier aggregation (CA) or dual connectivity (DC), there is only one serving cell, which may be referred to as the primary cell. For a UE in RRC_CONNECTED configured with CA/DC, the term “serving cells” may be used to denote a set of cells including the Special Cell(s) (SpCell) and all secondary cells. A Serving Cell may be a PCell, a PSCell. or an SCell described in the 3GPP Technical Specification (TS) 38.331.

Hybrid Automatic Repeat Request (HARQ): HARQ is a functionality that ensures delivery between peer entities at Layer 1 (i.e., Physical Layer). A single HARQ process supports one Transport Block (TB) when the physical layer is not configured for DL/UL spatial multiplexing, and a single HARQ process supports one or multiple TBs when the physical layer is configured for DL/UL spatial multiplexing. There is one HARQ entity per serving cell. Each HARQ entity supports a parallel (number) of DL and UL HARQ processes.

HARQ information: HARQ information for DL-shared channel (SCH) or for UL-SCH transmissions may include New Data Indicator (NDI), Transport Block size (TBS), Redundancy Version (RV), and HARQ process identity (ID).

Hybrid automatic repeat request acknowledgment (HARQ-ACK): A HARQ-ACK information bit value of 0 represents a negative acknowledgment (NACK) while a HARQ-ACK information bit value of 1 represents a positive acknowledgment (ACK).

Non-terrestrial networks (NTN) refer to networks, or segments of networks, using a spaceborne vehicle for transmission, such as Low Earth Orbiting (LEO) satellites and Geostationary Earth Orbiting (GEO) satellites. In 3GPP Release 17 (Rel-17) NTN working item (WI), transparent payload-based LEO scenario addressing at least 3GPP class 3 user equipment (UE) with Global Navigation Satellite System (GNSS) capability and with both Earth fixed beam (EFB) and Earth moving beam (EMB) footprint has been prioritized

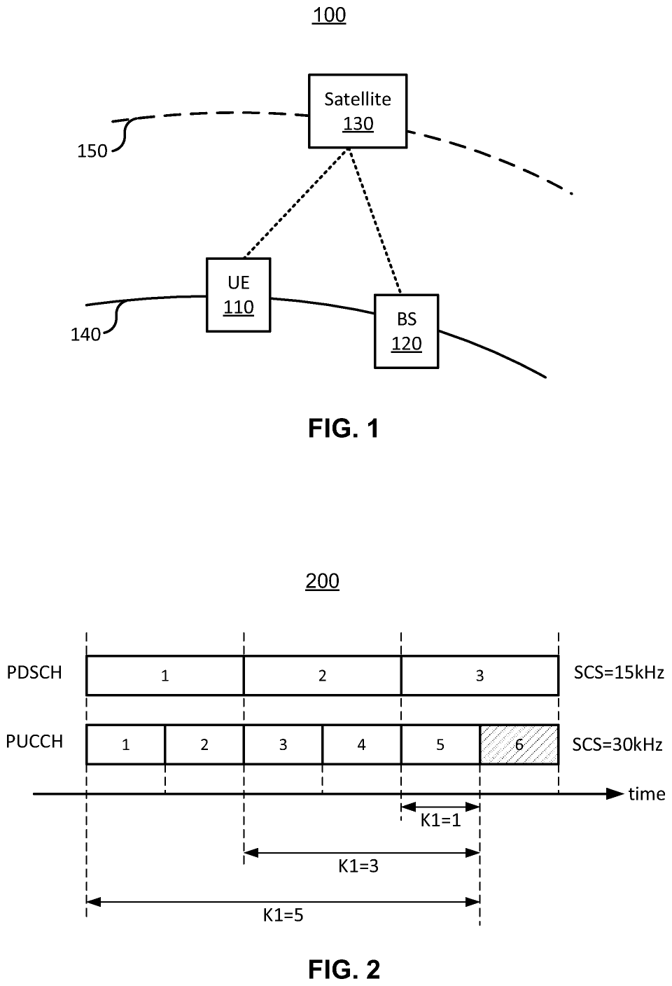

Transparent payload-based LEO network (NW) refers to a relay-based NTN. In this case, the LEO satellites simply perform amplify-and-forward in space, and the base station (e.g., gNB) is located on the ground connected to the core NW. The orbit of 600 km has been considered in the WI. FIG. 1 illustrates an NTN network 100 with an LEO satellite of transparent payload according to an implementation of the present disclosure. The satellite 130 may be on an orbit 150 of 600 km above the surface of the earth 140. The satellite 130 may act as a relay between the UE 110 and the BS 120. The satellite beam between the satellite 130 and the UE 110 may be an earth moving beam (EMB) or an earth fixed beam (EFB).

3GPP class 3 UE refers to Power Class UE 3. The definition is used for the uplink (UL) transmit (TX) power level set to be 23 dBm with a range of plus and minus 2 dB. This setting was mainly driven to ensure backward compatibility with prior technologies (e.g., Rel-15 NR/GSM/UMTS) so that network deployment topologies remain similar.

Global Navigation Satellite System (GNSS) refers to the standard generic term for satellite navigation systems that provide autonomous geo-spatial positioning with global coverage. GNSS may include, for example, the Global Positioning System (GPS), GLONASS, Galileo, Beidou, and other regional systems.

Earth moving beam (EMB) refers to the satellite beams of which the footprints on earth are moving with satellite. Cells on the ground are serviced by different beams with the satellite rotation.

Earth fixed beam (EFB) refers to the satellite beams of which the footprints on earth are fixed for a long time. The angle of the antenna for each beam can be adjusted during the moving of the satellite to provide service to a fixed area on earth for a long time. The major difference to the EMB situation is that the round-trip time (RTT) for a static device is varying with the elevation angle of beams. Each cell/area has the largest RTT with the minimum or maximum elevation angle.

K0: In NR, the K0 value may refer to the offset between the DL slot in which the physical downlink control channel (PDCCH) for DL scheduling is received and the DL slot in which PDSCH data is scheduled.

K1: In NR, the K1 value may refer to the offset between the DL slot in which the data is scheduled on PDSCH and the UL slot in which the ACK/NACK feedback for the scheduled PDSCH data needs to be sent.

K2: In NR, the K2 value may refer to the offset between the DL slot in which the PDCCH for UL scheduling is received and the UL Slot in which the UL data needs to be sent on a physical uplink shared channel (PUSCH).

Timing advance (TA) refers to the timing offset between UL and DL frames. The UL frames may be transmitted in advance based on a TA value, which may be indicated by NW. The TA is used to guarantee that UL signals from different UEs may be received at the NW side on time without interfering each other. The typical TA value is set to two times the propagation delay. The TA value matters because the NW needs this information to perform UL time scheduling (e.g., UL grants and UL slot offsets), ensure L1 synchronization (e.g., the timing advance group (TAG)-specific timer defined in Rel-15 NR), and enhance mobility (e.g., SSB-based measurement timing configuration (SMTC) measurement gap and conditional handover (HO)). In NTN, due to a large propagation delay, a UE may apply a large TA value. As a result, a large scheduling offset between its DL and UL frame may be needed.

Timing Relationships

Existing NR timing relations involving DL-UL timing interaction include, for example, an offset between a DL PDSCH and a UL HARQ feedback by K1, and an offset between DL DCI and UL PUSCH by K2. The timing relations may not hold when there is a large offset in the DL and UL frame timing at the UE side in NTN.

In Technical Report (TR) 38.821, the enhancement has been to introduce a new offset K_offset and apply it to modify the relevant timing relationships. The value of K_offset may be specified/configured per beam or per cell. The value of K_offset may be derived from broadcast information or be dedicatedly signaled by higher layers. The value range of K1 and/or K2 may be extended because of the K_offset. To avoid scheduling disorder, i.e., a scheduled UL transmission is earlier than its scheduling DCI, the value of K_offset may be equal to or greater than the current TA value if ignoring impacts of K1.

Type-1 HARQ-ACK Codebook

In NR, the type-1 HARQ-ACK codebook may be used for a UE to report HARQ-ACK information for a corresponding PDSCH reception or Semi Persistent Scheduling (SPS) PDSCH release.

A UL slot for transmitting the HARQ-ACK codebook may be indicated by a K1 value, which may be a value of a PDSCH-to-HARQ_feedback timing indicator field in a corresponding DC format 1_0 or DC format1_1.

In one implementation, the HARQ-ACK codebook size may be determined by at least one of the following elements:
A set of slot timing values K1. For DCI format 1_0, K1 may be provided by the slot timing values {1, 2, 3, 4, 5, 6, 7, 8}. For DCI format 1_1, K1 may be provided by a radio resource control (RRC) information element (IE) dIDataToUL-ACK.
A set of row indexes R of a table containing: slot offsets K0 (e.g., an offset between a scheduling DCI and the scheduled PDSCH), start and length indicator value (SLIV), and PDSCH mapping types for PDSCH reception.
A ratio between the DL subcarrier spacing (SCS) configuration and the UL SCS configuration.
Time division duplex (TDD) configuration for UL and DL slots.

In one implementation, the HARQ-ACK information bits in the codebook may be determined by at least one of the following processes:
if a UE does not receive a transport block (TB) or a code block group (CBG), due to the UE not detecting a corresponding DCI, the UE generates a NACK value for the TB or the CBG.
If a UE receives a TB or a CBG scheduled by a corresponding DCI, the UE generates HARQ-ACK information bit(s) according to decoding results of the received TB or the received CBG.

Issue #1: Timing Relationship Enhancement

If the new scheduling offset K_offset is configured, according to Rel-16 NR specs, the UE might be forced to monitor the PDSCH reception opportunities that never will happen and thus only generate NACK values in a HARQ-ACK codebook.

Issue #1-1: General Description for Type-1 HARQ-ACK Codebook May Need a New Offset.

Table 1 illustrates general description for Type-1 HARQ-ACK codebook in Rel-16 NR. The Type-1 HARQ-ACK codebook may be highly involved with the scheduling offset K1.

```
TABLE 1
3GPP TS 38.213 V16.0.0
A UE reports HARQ-ACK information for a corresponding PDSCH
reception or SPS PDSCH release only in a HARQ-ACK codebook
that the UE transmits in a slot indicated by a value of a PDSCH-
to-HARQ_feedback timing indicator field in a corresponding
DCI format 1_0 or DCI format 1_1.
[...]
The determination is based:
a) on a set of slot timing values K1 associated with the active UL BWP
      a. If the UE is configured to monitor PDCCH for DCI format
        1_0 and is not configured to monitor PDCCH for DCI
        format 1_1 on serving cell c, K1 is provided by the slot timing
        values {1, 2, 3, 4, 5, 6, 7, 8} for DCI format 1_0
      b. If the UE is configured to monitor PDCCH for DCI format
        1_1 for serving cell c, K1 is provided by dlDataToUL-ACK
        for DCI format 1_1
[...]
For the set of slot timing values K1, the UE determines a set of M_{A,c}
occasions for candidate PDSCH receptions or SPS PDSCH releases
according to the following pseudo-code.
```

For NTN, if the new scheduling offset K_offset is configured, the description above may need new wording to accommodate with Rel-16 NR. For example, the value of the PDSCH-to-HARQ feedback timing indicator field and the slot timing values K in Table 1 may need to be modified to take the new scheduling offset K_offset into consideration. The modification is disclosed in implementations #1-1 and #1-2.

Issue #1-2: If PDSCH Aggregation is Configured, a Valid PDSCH Reception Occasion May Need a New Offset.

Table 2 illustrates a process of PDSCH aggregation in Rel-16 NR. In Rel-16 NR, if PDSCH aggregation is provided, a PDSCH reception is repeated in multiple slots and the corresponding HARQ-ACK codebook is reported in a physical uplink control channel (PUCCH) in a slot indicated by the offset K1.

TABLE 2
3GPP TS 38.213 V16.0.0
If the UE is provided pdsch-AggregationFactor, N_{PDSCH}^{repeat} is a value of
pdsch-AggregationFactor; otherwise, N_{PDSCH}^{repeat} = 1. The UE reports
HARQ-ACK information for a PDSCH reception from slot n -
N_{PDSCH}^{repeat} + 1 to slot n only in a HARQ-ACK codebook that the UE
includes in a PUCCH or PUSCH transmission in slot n + k, where k
is a number of slots indicated by the PDSCH-to-HARQ feedback
timing indicator field in a corresponding DCI format or provided by
diDataToUL-ACK if the PDSCH-to-HARQ_feedback timing indicator
field is not present in the DCI format.

For NTN, if the scheduling offset K_offset is provided, the description above needs some modifications. For example, the value of the PDSCH-to-HARQ_feedback timing indicator field may need to be modified to take the new scheduling offset K_offset into consideration. The modification is disclosed in implementations #1-1 and #1-2.

Issue #1-3: If Different UL and DL Numerologies are Configured, the Codebook Size May Need a New Offset.

Table 3 illustrates a process of handling different UL and DL numerologies in Rel-16 NR. Numerologies of UL and DL may make an impact on Type-1 HARQ-ACK codebook determination.

TABLE 3

```
3GPP TS 38.213 V16.0.0
If mod(n_{U} − K_{1,k} + 1, max(2^{μUL - μDL}, 1)) = 0
  Set n_{D} = 0
  while n_{D} < max(2^{μDL - μUL}, 1)
    Set R to the set of rows
```

The notations used in Table 3 are described as follows. mod(X, Y) is a modulo operation that finds the remainder of a division after X is divided by Y. n_{U} is a UL slot in a PUCCH in which UE transmits HARQ-ACK information. K_{1,k} is the kth element in the set K1. μ_{DL} is the DL SCS index. μ_{UL} is the UL SCS index. n_{D} is an index of a DL slot within a UL slot. The slot numbers of n_{U} and K_{1,k} are counted based on the UL SCS.

The if statement in Table 3 is used when the UL SCS is greater than the DL SCS. FIG. 2 illustrates a scenario 200 in which the UL SCS is greater than the DL SCS according to an implementation of the present disclosure. The numbers illustrated in FIG. 2 represent the index of each DL slot or each UL slot. μ_{UL}=1 and the UL SCS is 30 kHz. μ_{L}=0 and the DL SCS is 15 kHz. The set of K1 values includes {1, 2, 3, 4, 5}. The UE transmits HARQ-ACK information in the UL slot #6 and n_{U}=6. Because max(2^{μ}^{_{UL}}^{-μ}^{_{UL}},1)=2, the if statement filters out K1 values 2 and 4. Therefore, only 3 HARQ-ACK bits are generated for K1=1, 3, and 5 to decrease the HARQ-ACK codebook size.

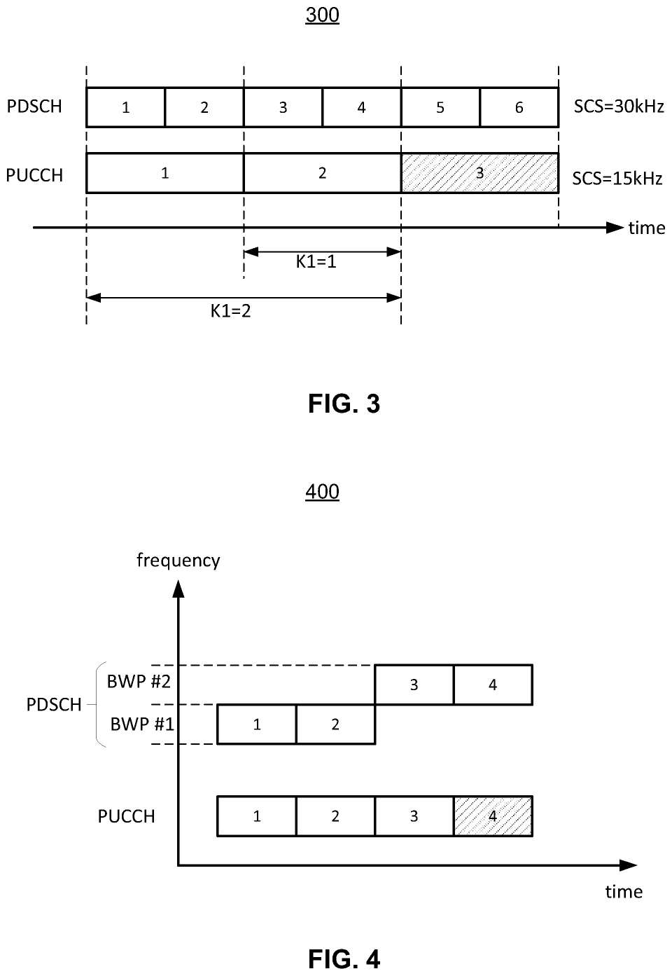

The while statement in Table 3 is used when the DL SCS is greater than the UL SCS. FIG. 3 illustrates a scenario 300 in which the DL SCS is greater than the UL SCS according to an implementation of the present disclosure. The numbers illustrated in FIG. 3 represent the index of each DL slot or each UL slot. μ_{UL}=0 and the UL SCS is 15 kHz. μ_{DL}=1 and the DL SCS is 30 kHz. The set of K1 values includes {1, 2}. The UE transmits HARQ-ACK information in the UL slot #3 and n_{U}=3. The while statement adds 2 DL slots within a UL slot by introducing the index n_{D}. Therefore, 4 HARQ-ACK bits are generated for K1=1 and 2 to increase the HARQ-ACK codebook size.

For NTN, if the scheduling offset K_offset is provided, the description in Table 3 may need to be modified. For example, K_{1,k} (the set K1) in Table 3 may need to be modified to take the new scheduling offset K_offset into consideration. The modification may not change the determination of the codebook size. The modification is disclosed in implementations #1-1 and #1-2.

Issue #1-4: If a UL Bandwidth Part (BWP) or a DL BWP Change Happens, a Valid PDSCH Reception Occasion May Need a New Offset

Table 4 illustrates a process of BWP change in Rel-16 NR. When an active DL BWP change happens before sending HARQ-ACK information, the PDSCH reception occasions on the old DL BWP may be ignored. The same consideration is applied for an active UL BWP change. The PDSCH reception occasions related to the old UL BWP may be dropped.

TABLE 4
3GPP TS 38.213 V16.0.0
if slot n_{U} starts at a same time as or after a slot for an active DL BWP
change on serving cell c or an active UL BWP change on the PCell
and slot (n_{U} − K_{1,k}) · 2^{μDL - μUL}] + n_{D} is before the slot for the active DL
BWP change on serving cell c or the active UL BWP change on the PCell
n_{D} = n_{D} + 1;
else
[...]

In Table 4, when the if statement holds, the DL slot index n_{D} will add one (i.e., n_{D}=n_{D}+1 in Table 4), which means that the UE drops HARQ-ACK information bit(s) for the corresponding PDSCH reception occasion that is before the slot for the BWP change.

FIG. 4 illustrates a process 400 of an active DL BWP change according to an implementation of the present disclosure. An active DL BWP change happens on DL slot #3. If DL and UL have the same SCS, n_{D} is set to zero. The UE transmits HARQ-ACK information in the UL slot #4 and n_{U}=4. When K_{1,k}=2, the DL slot index is 2. According to Table 4, the DL slot #2 (n_{U}=4 and K_{1,k}=2) is before the DL slot #3 for the active DL BWP change. As a result, the PDSCH reception occasion for the DL slot #2 is dropped. Similarly, the PDSCH reception occasion for the DL slot #1 is dropped as well. Therefore, the HARQ-ACK codebook size is one in this example, although there are PDSCH reception in the DL slots #1, #2 and #3.

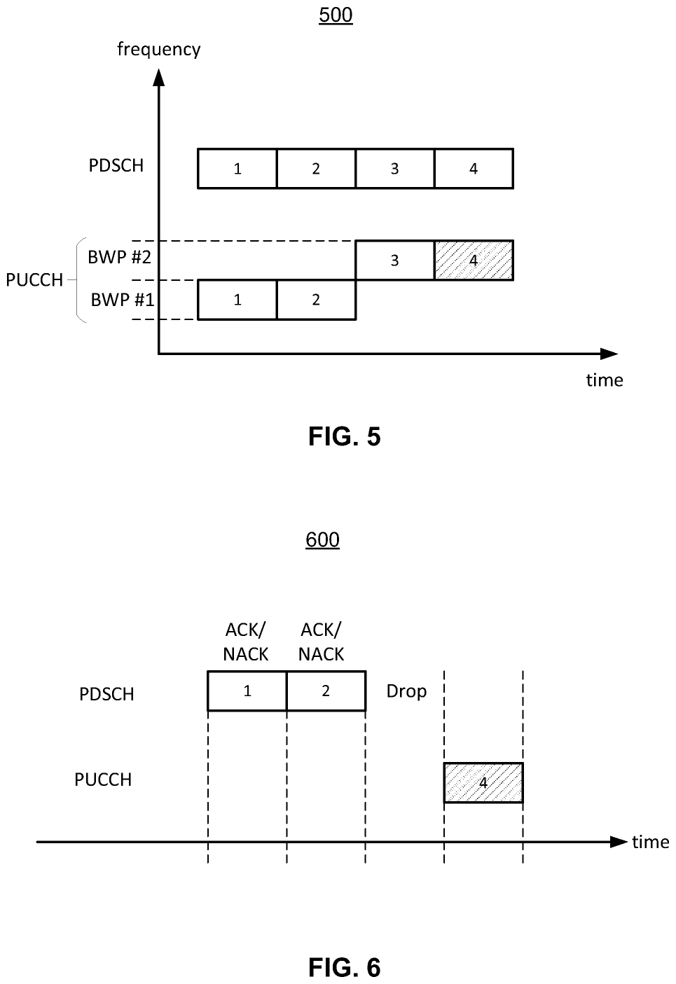

FIG. 5 illustrates a process 500 of an active UL BWP change according to an implementation of the present disclosure. An active UL BWP change happens on UL slot #3. The UE transmits HARQ-ACK information in the UL slot #4 and n_{U}=4. The PDSCH reception occasions before the UL slot #3 may be dropped. Therefore, the PDSCH reception occasions for the DL slot #1 and #2 are dropped. The codebook size is one, which is the same as the example illustrated in FIG. 4.

For NTN, if the scheduling offset K_offset is provided, the description in Table 4 may need to be modified. For example, K_{1,k} (the set K1) in Table 4 may need to be modified to take the new scheduling offset K_offset into consideration. The modification may change the determination of the codebook size. The modification is disclosed in implementations #1-1 and #1-2.

Issue #1-5: If TDD is Configured, a Valid PDSCH Reception Occasion May Need a New Offset.

Table 5 illustrates a process of receiving TDD configuration in Rel-16 NR. If a UE is provided the TDD frame configuration, the PDSCH reception occasions on the UL slots may be dropped.

```
TABLE 5
3GPP TS 38.213 V16.0.0
if the UE is provided tdd-UL-DL-ConfigurationCommon,
or tdd-UL-DL-ConfigurationDedicated and, for each slot from slot
[(n_{U} − K_{1,k}) · 2^{μDL - μUL}] + n_{D} − N_{PDSCH}^{repeat} + 1 to slot [(n_{U} − K_{1,k}) ·
2^{μDL - μUL}] + n_{D} at least one symbol of the PDSCH time resource
derived by row r is configured as UL where K_{1,k} is the k-th slot timing
value in set K₁,
    R = R\r;
else
    r = r + 1;
end if
```

In Table 5, the notation R=R†r refers to the complement of r, meaning the set R subtracts r, or the set R removes the r^{th} row in R. FIG. 6 illustrates a process 600 of receiving TDD frame configuration according to an implementation of the present disclosure. The UE transmits HARQ-ACK information in the UL slot #4 and n_{U}=4. According to Table 5, the PDSCH reception occasion in the DL slot #3 may be dropped.

For NTN, if the scheduling offset K_offset is provided, the description in Table 5 may need to be modified. For example, K_{1,k} (the set K1) in Table 5 may need to be modified to take the new scheduling offset K_offset into consideration. The modification may change the determination of the codebook size. The modification is disclosed in implementations #1-1 and #1-2.

In one implementation, the NW may configure the UE with the following parameters via RRC messages.
pdsch-HARQ-ACK-Codebook: PDSCH HARQ-ACK codebook is either semi-static (Type-1 HARQ-ACK codebook) or dynamic (Type-2 HARQ-ACK codebook).
pdsch-AggregationFactor: Number of repetitions for data. When the field is absent the UE applies the value 1.
dl-DataToUL-ACK: List of timing for given PDSCH to the DL ACK in slot.
dl-DataToUL-ACK-NTN: List of timing for given PDSCH to the DL ACK for NTN.
K_offset-NTN: a new timing offset K_offset for given DL to UL

In one example, K_offset-NTN may include more than one values. A medium access control (MAC) control element (CE) signaling may be used to activate one value to be applied. There may be cases where K_offset-NTN includes more than one values and MAC CE signaling is not received for activation of one specific value. In such case the UE may assume to apply a default value from the K_offset-NTN. The default value may be the first indexed value or the last indexed value. In the following disclosure, a single-valued K_offset-NTN is assumed for the explanation. However, this does not prevent one from extending it to a multi-valued K_offset-NTN based on the example above.

In one implementation, the NW may indicate to the UE the following information via physical layer signaling, such as DCI.
PDSCH-to-HARQ_feedback timing indicator field. For DCI format 1_0, the field values map to {1, 2, 3, 4, 5, 6, 7, 8}. For DCI format 1_1, the field values map to values for a set of a number of slots provided by dlDataToUL-ACK.

If K_offset-NTN is configured, the UE may report HARQ-ACK information in a HARQ-ACK codebook for PDSCH reception or SPS PDSCH release. The UE may transmit the HARQ-ACK codebook in a PUCCH in slot n_{U}=n+k+K_offset.

The slot n based on the UL SCS may be used for a PDSCH reception, a SPS PDSCH reception ending or a SPS PDSCH release.

The timing offset k based on the UL SCS may be provided by DCI format 1_0, DCI format 1_1, or dl-DataToUL-ACK.

The timing offset K_offset based on the UL SCS may be provided by the RRC parameter K_offset-NTN configured per cell, other Layer-1/Layer-2 signaling (e.g., a MAC-CE command), a DCI indication, or any combination thereof. For example, a higher layer signaling may define a candidate set while a lower layer signaling may indicate one specific element from the candidate set dynamically.

For a serving cell c, an active DL BWP, and an active UL BWP, the UE determines a set of M_{A,c} occasions for candidate PDSCH receptions for which the UE can transmit corresponding HARQ-ACK information in a PUCCH in slot n_{U}. The determination may be based on the following options.

If the scheduling offset K_offset is provided (e.g., configured via RRC signaling), new UE behaviors may be needed upon Rel-16 Type-I HARQ-ACK codebook. Two implementations are disclosed.

Implementation #1-1: Adding New Definition for the Set of Slot Timing Values K1

In Rel-16 NR, the set of K1 is based on the default range or configured by dlDataToUL-ACK.

In Rel-17 NTN, the set of K1 may include at least one of the K_offset, dlDataToUL-ACK, and the default range.

The Type-1 HARQ-ACK codebook determination may redefine the K1 set, which is based on a set of slot timing values K1 associated with the active UL BWP.

If the UE is configured to monitor PDCCH for DCI format 1_0 and is not configured to monitor PDCCH for DCI format 1_1 on serving cell c, K1 is provided by the slot timing values {1, 2, 3, 4, 5, 6, 7, 8} for DCI format 1_0

If the UE is configured to monitor PDCCH for DCI format 1_1 for serving cell c, K1 is provided by dlDataToUL-ACK for DCI format 1_1

If the UE is configured K_offset-NTN, and
If the UE is configured DCI format 1_0 and is not configured DCI format 1_1 on serving cell c, K1 may be provided by the slot timing values {1, 2, 3, 4, 5, 6, 7, 8}+K_offset for DCI format 1_0, where K_offset is provided by K_offset-NTN.
If the UE is configured to monitor PDCCH for DCI format 1_1 for serving cell c, K1 may be a combination provided by dlDataToUL-ACK for DCI format 1_1 and by K_offset-NTN for K_offset.
For DCI format 1_1, K1 may be provided by a single parameter dl-DataToUL-ACK-NTN configured by RRC rather than via the interaction between the two RRC parameters mentioned above.
If dl-DataToUL-ACK-NTN is provided, the UE does not expect to be indicated by DCI format 1_0 a slot timing value for transmission of HARQ-ACK information that does not belong to the intersection of the set of slot timing values {1, 2, 3, 4, 5, 6, 7, 8}+K_offset and the set of slot timing values provided by dl-DataToUL-ACK-NTN for the active DL BWP of a corresponding serving cell.

For the set of slot timing values K1, the UE may determine a set of M_{A,c} occasions for candidate PDSCH receptions or SPS PDSCH releases according to the 3GPP TS 38.213 V16.0.0.

For the set of M_{A,c} occasions, the UE may determine HARQ-ACK information bits of a HARQ-ACK codebook for transmission in a PUCCH according to the 3GPP TS 38.213 V16.0.0. The cardinality of the set M_{A,c} defines a total number Mc of occasions for PDSCH reception or SPS PDSCH release for serving cell c corresponding to the HARQ-ACK information bits.

For HARQ-ACK bit determination, if the UE does not receive a transport block or a CBG, due to the UE not detecting a corresponding DCI format 1_0 or DCI format 1_1, the UE generates a NACK value for the transport block or the CBG.

Implementation #1-2: Adding K_Offset to the Set of K1

Instead of redefining the K1 set, the new offset K_offset may be added directly to the description/statements associated with the K1 set in the Tables disclosed previously. In one implementation, the K1 value in Table 1 through Table 5 (e.g., the slot timing values K1, the value of the PDSCH-to-HARQ_feedback timing indicator field, K_{1,k}) may be replaced with K11+K_offset.

The HARQ-ACK codebook determination may integrate K_offset into the pseudo-code for a serving cell c. Table 6 illustrates a process of determining M_{A,c}. K_{offset,c} denotes a configured K_{offset} value in the serving cell c.

TABLE 6

```
Set j = 0 − index of occasion for candidate PDSCH reception or SPS PDSCH release
Set B = Ø
Set M_{A,c} = Ø
Set [symbol]  (K₁) to the cardinality of set K₁
Set k =0 − index of slot timing values K_{1,k}, in descending order of the slot timing values, in set
K₁ for serving cell [symbol]
while k < [symbol]  (K₁)
  if mod(nᵤ − K_{1,k} − K_{offset,c} + 1,max(2^{μ}^{_{UL}} ⁻ ^{μ}^{_{DL}}, 1)) = 0
          Set n_{D} = 0 − index of a DL slot within an UL slot
          while n_{D} < max(2^{μ}^{_{DL}} ⁻ ^{μ}^{_{UL}} ,1)
          Set R to the set of rows
          Set [symbol]  (R) to the cardinality of R
          Set r = 0 − index of row in set R
      if slot nᵤ starts at a same time as or after a slot for an active DL BWP change on serving
      cell c or an active UL BWP change on the PCell and slot └(nᵤ − K_{1,k} − K_{offset,c}) ·
      2^{μ}^{_{DL}} ⁻ ^{μ}^{_{UL}}┘ + n_{D} is before the slot for the active DL BWP change on serving cell c or
      the active UL BWP change on the PCell
        n_{D} = n_{D} + 1;
      else
        while r < [symbol]  (R)
          if the UE is provided tdd-UL-DL-ConfigurationCommon, or tdd-UL-DL-
          ConfigurationDedicated and, for each slot from slot └(nᵤ − K_{1,k} − K_{offset,c}) ·
          2^{μ}^{_{DL}} ⁻ ^{μ}^{_{UL}}┘ + n_{D} − N_{PDSCH}^{repeat} +1 to slot └(nᵤ − K_{1,k} − K_{offset,c}) · 2^{μ}^{_{DL}} ⁻ ^{μ}^{_{UL}}┘ +
          n_{D}, at least one symbol of the PDSCH time resource derived by row r is
          configured as UL where K_{1,k} is the k-th slot timing value in set K₁ ,
            R = R\r ;
          else
            r = r+1 ;
          end if
        end while
        if the UE does not indicate a capability to receive more than one unicast PDSCH per
          slot and R ≠ Ø ,
          M_{A,c} = M_{A,c} ∪ j ;
          j = j+1 ;
          The UE does not expect to receive SPS PDSCH release and unicast PDSCH in a
            same slot;
        else
          Set [symbol]  (R) to the cardinality of R
          Set m to the smallest last OFDM symbol index, as determined by the SLIV,
            among all rows of R
          while R ≠ Ø
            Set r = 0
            while r < [symbol]  (R)
              if S ≤ m for start OFDM symbol index S for row r
                b_{r,k,n}_{_{D}} = j ; − index of occasion for candidate PDSCH reception or SPS
                  PDSCH release associated with row r
                R = R\r ;
                B = B∪b_{r,k,n}_{_{D}} ;
              else
                r = r+1;
              end if
            end while
            M_{A,c} = M_{A,c}∪j;
            j = j+1 ;
            Set m to the smallest last OFDM symbol index among all rows of R ;
          end while
        end if
        n_{D} = n_{D} + 1;
      end if
      end while
  end if
  k = k+1;
end while
```

The value of K_{offset,c} may be provided by K_offset-NTN per cell. If K_offset-NTN is not provided in a serving cell c, the value may be set to zero, e.g., K_{offset,c}=0.

Once M_{A,c} is determined, the subsequent procedure for generating the Type-I HARQ-ACK codebook may be the same as that in implementation #1-1.

UL Power Control for PUCCH

In Rel-16 NR, the standard specifies two different ways to determine the number of HARQ-ACK bits for PUCCH power control. The determination is based on Uplink Control Information (UCI) bits.

If the number of UCI bits is larger than 11 bits, the number of HARQ-ACK bits for PUCCH power control is the size of Type-1 HARQ-ACK codebook.

If the number of UCI bits is smaller than or equal to 11, the number of HARQ-ACK bits for PUCCH power control is determined by the number of PDSCHs received by UE (which may be smaller than the codebook size due to precluding some NACK values that NW has known), instead of the size of Type-1 HARQ-ACK codebook.

The reason behind this is that when UCI payload size is smaller than or equal to 11 bits, Reed-Muller (RM) code is used; and when UCI payload size is greater than 11 bits, the Polar code is adopted.

For RM code, to achieve effective coding rates of HARQ-ACK report, the redundant information bits should be precluded. Since the bits corresponding to PDSCHs that are not transmitted by the NW are fully known by the NW, those bits are redundant information and should not be counted in the coding rate for UL power control.

The reason for precluding redundant bits is that it evaluates the required UL power by Shannon channel capacity considering different modulation schemes and channel coding rates applied.

HARQ-ACK Disabling in NTN

In NTN, the propagation delays may range from several milliseconds to hundreds of milliseconds depending on the satellite orbit. To prevent the reduction in peak data rates due to using only 16 parallel Stop-and-Wait HARQ processes in Rel-16 NR, the network may disable UL HARQ feedback for DL transmission at the UE receiver to support long propagation delays.

Even if HARQ feedback (also referred to as HARQ-ACK feedback in the present disclosure) is disabled, the HARQ processes may still be configured. Enabling or disabling of HARQ feedback may be a network decision signaled semi-statically to the UE by RRC signaling. The enabling or disabling of HARQ feedback for DL transmission may be configurable on a per UE basis and a per HARQ process basis via RRC signaling.

Issue #2: UL Power Control Considering Disabled HARQ Feedback

If disabling of HARQ-ACK is configured on a per HARQ process basis, according to Rel-16 NR specifications, the UE might over determinate/overestimate the PUCCH power by counting the number of PDSCHs received by UE, regardless of the possibility that HARQ-ACK related to the PDSCHs may have been disabled by a base station (gNB).

Table 7 illustrates a process of determining UL transmission power in Rel-16 NR. The transmission power for a PUCCH is determined by a UE based on the number of HARQ-ACK information bits if Type-i HARQ-ACK codebook is configured.

TABLE 7
3GPPTS 38.213 V16.0.0 (2019-12)

```
If O_{ACK} + O_{SR} + O_{CSI} ≤ 11, the UE determines a number of HARQ-ACK information bits n_{HARQACK}
for obtaining a transmission power for a PUCCH, as described in Clause 7.2.1, as
${n}_{HARQACK} = {\sum }_{c = 0}^{{N}_{cells}^{DL} - 1} {\sum }_{m = 0}^{{M}_{c} - 1} {N}_{m , c}^{received} + {\sum }_{c = 0}^{{N}_{cells}^{DL} - 1} {\sum }_{m = 0}^{{M}_{c} - 1} {N}_{m , c}^{received , CBG}$
where
  • N_{m,c}^{received} is the number of transport blocks the UE receives in PDSCH reception occasion
    m for serving cell c if harq-ACK-SpatialBundlingPUCCH and PDSCH-
    CodeBlockGroupTransmission are not provided, or the number of transport blocks the
    UE receives in PDSCH reception occasion m for serving cell c if PDSCH-
    CodeBlockGroupTransmission is provided and the PDSCH reception is scheduled by a
    DCI format 1_0, or the number of PDSCH receptions if harq-ACK-
    SpatialBundlingPUCCH is provided or SPS PDSCH release in PDSCH reception
    occasion m for serving cell c and the UE reports corresponding HARQ-ACK
    information in the PUCCH.
  • N_{m,c}^{received,CBG} is the number of CBGs the UE receives in a PDSCH reception occasion m
    for serving cell c if PDSCH-CodeBlockGroupTransmission is provided and the PDSCH
    reception is scheduled by a DCI format 1_1 and the UE reports corresponding HARQ-
    ACK information in the PUCCH.
```

The notations used in Table 7 are described as follows. O_{ACK}: the total number of HARQ-ACK information bits of a HARQ-ACK codebook for transmission in a PUCCH according to TS 38.213. O_{SR}: the total number of Scheduling Request (SR) information bits. O_{CSI}: the total number of channel state information (CSI) information bits. N_{cells}^{DL}: the total number of serving cells. Mc: a total number of occasions for PDSCH reception or SPS PDSCH release for serving cell c corresponding to the HARQ-ACK information bits.

Note that O_{ACK} may contain NACK bits for PDSCH reception occasions where a UE does not receive a TB or a CBG due to not detecting a corresponding DCI, which implies O_{ACK}≥n_{HARQ-ACK}. These bits are probably known by a base station (e.g., gNB), and therefore, they shall be precluded from counting PUCCH transmission power.

Then, the number of n_{HARQ-ACK} is used for generating PUCCH transmission power. Table 8 illustrates a process of determining the UL transmission power when the UCI payload size is smaller than or equal to 11.

TABLE 8
3GPPTS 38.213 V16.0.0

```
If a UE transmits a PUCCH on active UL BWP b of carrier f in the primary cell c using
PUCCH power control adjustment state with index l, the UE determines the PUCCH
transmission power P_{PUCCHb,f,c} (i,qᵤ,q_{d},l) in PUCCH transmission occasion i as
${P}_{PUCHH , b , f , c} ( i , {q}_{u} , {q}_{d} , l ) = min \{ \begin{matrix}{P}_{CMAX , f , c} ( i ) , \\ {P}_{O\_PUCCH , b , f , c} + 10 {log}_{10} ( {2}^{μ} \cdot {M}_{RB , b , f , c}^{PUCCH} ( i ) ) + {PL}_{b , f , c} ( {q}_{d} ) + {Δ}_{P\_PUCCH} ( F ) + {Δ}_{TF , b , f , c} ( i ) + {g}_{b , f , c} ( i , l )\end{matrix} \} [ dBm ]$
where
  • Δ_{TF,b,f,c} (i) is a PUCCH transmission power adjustment component on active UL BWP b
    of carrier f of primary cell c
    ○ For a PUCCH transmission using PUCCH format 2 or PUCCH format 3 or
      PUCCH format 4 and for a number of UCI bits smaller than or equal to 11,
      Δ_{TF,b,f,c}(i) = 10log₁₀(K₁ · (n_{HARQACK}(i) + O_{SR}(i) + O_{SCI}(i))/N_{RE} (i)), where
      ▪ n_{HARQACK}(i) is a number of HARQ-ACK information bits that the UE
        determines as described in Clause 9.1.2.1 for Type-1 HARQ-ACK
        codebook and as described in Clause 9.1.3.1 for Type-2 HARQ-ACK codebook.
      ▪ If the UE is not provided with pdsch-HARQ-ACK-Codebook,
        n_{HARQACK}(i) = 1 if the UE includes a HARQ-ACK information bit in the
        PUCCH transmission; otherwise, n_{HARQACK}(i) = 0
```

Note that Δ_{TF,b,f,c}(i) is essentially a rewrite of the Shannon channel capacity C=log₂(1+SNR), trying to model how the required received power varies when the number of information bits per resource element varies due to different modulation schemes and channel coding rates. For the information bits for HARQ-ACK, the parameter of n_{HARQ-ACK} is adapted.

Besides, if a UE is not provided pdsch-HARQ-ACK-Codebook, the UE generates at most one HARQ-ACK information bit, specified in TS 38.213. Therefore, n_{HARQ-ACK}=1 means that the UE receives a TB or a CBG by detecting a corresponding DCI. Then, the UE generates a HARQ-ACK information bit in the PUCCH transmission; otherwise n_{HARQ-ACK}=0.

In Rel-17 NTN, when HARQ-ACK is disabled on a per UE or per HARQ process basis, the determination of HARQ-ACK information bits in the Type-1 HARQ codebook may be implemented by:

If a UE does not receive a TB or a CBG, due to the UE not detecting a corresponding DCI, the UE generates a NACK value for the TB or the CBG.

If a UE receives a TB or a CBG scheduled by a corresponding DCI, the UE generates HARQ-ACK information bit(s) corresponding to decoding results of the received TB or the received CBG.

If the corresponding DCI indicates a HARQ process ID that is ‘disabling’ configured by a gNB, the UE may act based on at least one of the following implementations.
Implementation #2-1: drop the HARQ-ACK information bit(s).
Implementation #2-2: replace the HARQ-ACK information bit(s) with NACK value(s) irrespective of the decoding results.
Implementation #2-3: keep the HARQ-ACK information bit(s) unchanged.

For implementations #2-1 through #2-3, the UE may report or drop the HARQ-ACK bits that the NW has already known. However, these bits may be precluded in n_{HARQ-ACK} for the PUCCH transmission power.

When HARQ-ACK is disabled on a per UE or per HARQ process basis, the number of HARQ-ACK information bits n_{HARQ-ACK} for obtaining a transmission power for a PUCCH may be associated with a list of disabled HARQ process IDs if the disabling is on a per HARQ process basis or associated with a HARQ disabling indication if the disabling is on a per UE basis.

In one implementation, the NW may configure the UE with the following parameters via RRC messages.
harq-ACK-SpatialBundlingPUCCH: Enables spatial bundling of HARQ ACKs. It is configured per cell group (i.e. for all the cells within the cell group) for PUCCH reporting of HARQ-ACK.
PDSCH-CodeBlockGroupTransmission: Enables CBG transmission of HARQ ACKs.
nrofHARQ-ProcessesForPDSCH: The number of HARQ processes to be used on the PDSCH of a serving cell. If the field is absent, the UE uses 8 HARQ processes.
harq-ACK-Disabled-List: list of HARQ processes ID(s) for HARQ-ACK disabling.
harq-ACK-Disabled-per-UE: the identifier for disabling HARQ-ACK processes on a per UE basis.

In one implementation, the NW may indicate to the UE the following information via physical layer signaling, such as DCI.
HARQ process number: assignment for a HARQ process ID. 4 bits for DCI format 0_0 and format 0_1.

If a UE transmits a PUCCH in the primary cell c, the UE may determine the PUCCH transmission power in a PUCCH occasion based on the number of HARQ-ACK information bits n_{HARQ-ACK}.

If harq-ACK-Disabled-List is provided, the UE may have the following UE behavior.

If O_{ACK}+O_{SR}+O_{SR}+O_{CSI}≤11, the UE determines n_{HARQACK} for obtaining a transmission power for a PUCCH as

$${n}_{HARQACK} = {\sum }_{c = 0}^{{N}_{cells}^{DL} - 1} {\sum }_{m = 0}^{{M}_{c} - 1} {N}_{m , c}^{received} + {\sum }_{c = 0}^{{N}_{cells}^{DL} - 1} {\sum }_{m = 0}^{{M}_{c} - 1} {N}_{m , c}^{receivedCBG}$$

If harq-ACK-SpatialBundlingPUCCH and PDSCH-CodeBlockGroupTransmission are not provided; or if PDSCH-CodeBlockGroupTransmission is provided and the PDSCH reception is scheduled by a DCI format 1_0:
If harq-ACK-Disabled-List is provided, N_{m,c}^{received} is the number of TBs that the UE receives in PDSCH reception occasion m for serving cell c, and the PDSCH reception occasion m scheduled by a DCI format is not associated with HARQ process ID(s) included in a list provided by harq-ACK-Disabled-List.
Else if harq-ACK-Disabled-List is not provided, N_{m,c}^{received} is the number of TBs that the UE receives in PDSCH reception occasion m for serving cell c.

If harq-ACK-SpatialBundlingPUCCH is provided; or if SPS PDSCH release in PDSCH reception occasion m for serving cell c and the UE reports corresponding HARQ-ACK information in the PUCCH:
If harq-ACK-Disabled-List is provided, N_{m,c}^{received} is the number of PDSCH receptions, and the PDSCH reception occasion m scheduled by a DCI format is not associated with HARQ process ID(s) included in a list provided by harq-ACK-Disabled-List.
Else if harq-ACK-Disabled-List is not provided, N_{m,c}^{received} is the number of PDSCH receptions.

If PDSCH-CodeBlockGroupTransmission is provided; and if the PDSCH reception is scheduled by a DCI format 1_1; and if the UE reports corresponding HARQ-ACK information in the PUCCH:
if harq-ACK-Disabled-List is provided, N_{m,c}^{receivedCBG} is the number of CBGs the UE receives in a PDSCH reception occasion m for serving cell c, and the PDSCH reception occasion m scheduled by a DCI format is not associated with HARQ process ID(s) included in a list provided by harq-ACK-Disabled-List.
Else if harq-ACK-Disabled-List is not provided, N_{m,c}^{receivedCBG} is the number of CBGs the UE receives in a PDSCH reception occasion m for serving cell c.

If the UE is not provided with pdsch-HARQ-ACK-Codebook, if the UE includes a HARQ-ACK information bit in the PUCCH transmission, and if the PUCCH transmission for a PDSCH reception or a SPS PDSCH release scheduled by a DCI format on a PDCCH that is not associated with HARQ process ID(s) included in a list provided by harq-ACK-Disabled-List, if configured: n_{HARQ-ACK}=1; otherwise n_{HARQ-ACK}=0

If harq-ACK-Disabled-per-UE is provided, the UE may have the following UE behavior: If HARQ-ACK is disabled on a per UE basis, provided by harq-ACK-Disabled-per-UE, the UE determines n_{HARQ-ACK} or O_{ACK} for obtaining a transmission power for a PUCCH as ‘zero’, i.e., n_{HARQ-ACK}=0 and O_{ACK}=0.

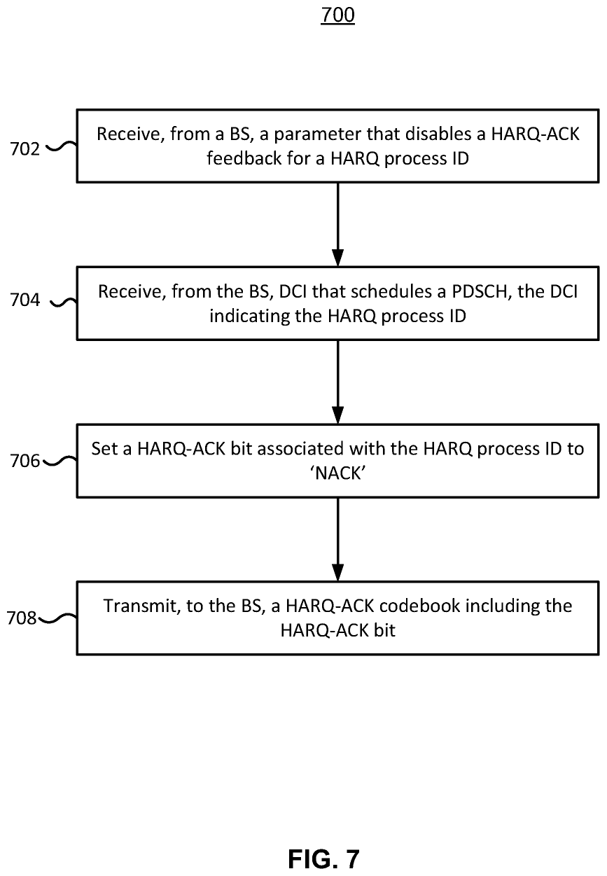

FIG. 7 illustrates a method 700 for handling HARQ-ACK feedback performed by a UE according to an implementation of the present disclosure. In action 702, the UE receives, from a BS, a parameter that disables a HARQ-ACK feedback for a HARQ process ID. In one implementation, the parameter may be received via RRC signaling. For example, the BS may transmit an RRC configuration to the UE for disabling the HARQ-ACK feedback. In one implementation, the parameter may be received via broadcast system information, a DL MAC CE, or DCI.

In one implementation, the disabling of the HARQ-ACK feedback may be on a per HARQ process basis. The base station may configure/indicate a specific HARQ process ID for which the HARQ-ACK feedback is disabled. In one implementation, the parameter may include a list of HARQ process IDs to indicate that HARQ-ACK feedbacks for the list of HARQ process IDs are disabled. The list of HARQ process IDs may include one or more HARQ process IDs.

In action 704, the UE receives, from the BS, DCI that schedules a PDSCH, the DCI indicating the HARQ process ID. The BS transmits DL data via the scheduled PDSCH to the UE. Because the HARQ-ACK feedback has been disabled for the indicated HARQ process ID, the BS may not need to read/decode the HARQ-ACK feedback from the UE. Therefore, the UE may not need to transmit the ‘real’ meaningful HARQ-ACK feedback to the BS.

In action 706, the UE sets a HARQ-ACK bit associated with the HARQ process ID to ‘NACK’. The UE may set the HARQ-ACK bit to ‘NACK’ no matter whether the UE successfully receives the DL data from the BS. For example, the UE may even set the HARQ-ACK bit to ‘NACK’ before the UE starts decoding the received data.

In action 708, the UE transmits, to the BS, a HARQ-ACK codebook including the HARQ-ACK bit. The HARQ-ACK codebook may include multiple bits, with each bit corresponding to a specific HARQ process ID. For example, the HARQ-ACK codebook may include a first bit corresponding to a first HARQ process ID for which the HARQ-ACK feedback is disabled and a second bit corresponding to a second HARQ process ID for which the HARQ-ACK feedback is not disabled. The UE may set the first bit to ‘NACK’ and set the second bit depending on whether data reception associated with the second HARQ process ID is successful.

The HARQ-ACK codebook may be transmitted on a PUCCH. The UE may perform UL power control for the HARQ-ACK codebook according to the disabled HARQ process ID(s). In one implementation, the UE may obtain an adjusted number of HARQ-ACK bits by precluding the HARQ-ACK bit associated with the HARQ process ID. Because the HARQ-ACK bit associated with the HARQ process ID is set to ‘NACK’ (for example, the HARQ-ACK bit is fixed to ‘NACK’ until the UE receives an updated configuration that changes the disabled HARQ process ID(s)), the HARQ-ACK bit may be precluded for UL transmission power. The UE may determine a transmission power for the PUCCH according to the adjusted number of HARQ-ACK bits. Detailed implementations of UL power control may be referred to Issue #2 in the present disclosure.

In one implementation, the UE may receive, from the BS, a timing offset (e.g., K_offset) used in NTN. The timing offset may be associated with a time interval between the PDSCH and the transmission of the HARQ-ACK codebook. For example, the timing offset (e.g., K1) used in the Terrestrial Networks (TN) may be different from the time offset used in the NTN (e.g., a parameter associated with K_offset) because of the long propagation delay characteristic in the NTN.

In one implementation, the UE may determine candidate PDSCH reception occasions corresponding to the HARQ-ACK codebook according to the timing offset. For example, the set of K1 values may be redefined based on the timing offset (e.g., K_offset), and the PDSCH reception occasions may be derived from the redefined set of K1 values. Detailed implementations may be referred to implementation #1-1 of the present disclosure.

In one implementation, the UE may receive, from the BS, a k1 value that indicates a time difference between the PDSCH and the transmission of the HARQ-ACK codebook in Terrestrial Networks (TN). The UE may obtain the time interval between the PDSCH and the transmission of the HARQ-ACK codebook in the NTN by adding the k1 value with the timing offset. Detailed implementations may be referred to implementation #1-2 of the present disclosure. For example,

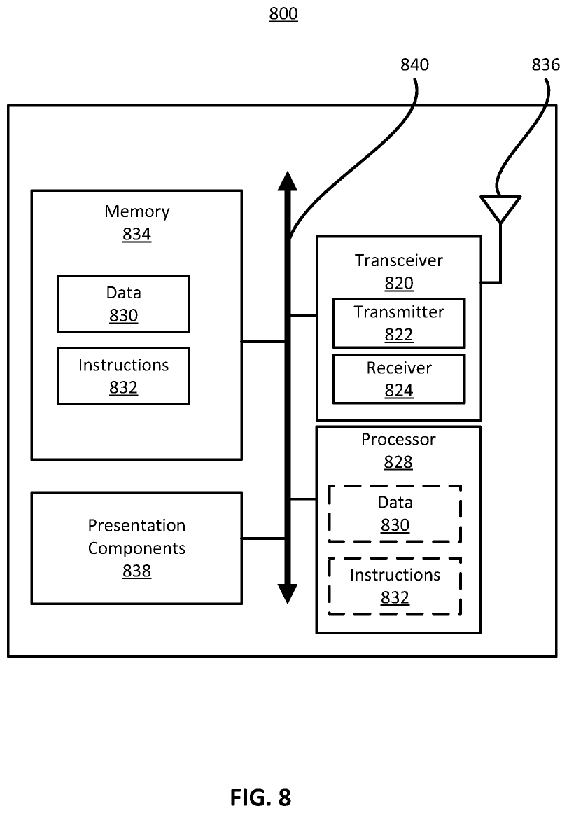

FIG. 8 is a block diagram illustrating a node 800 for wireless communication according to an implementation of the present disclosure. As illustrated in FIG. 8, a node 800 may include a transceiver 820, a processor 826, a memory 828, one or more presentation components 834, and at least one antenna 836. The node 800 may also include a radio frequency (RF) spectrum band module, a base station communications module, a network communications module, and a system communications management module, Input/Output (I/O) ports, I/O components, and a power supply (not illustrated in FIG. 8).

Each of the components may directly or indirectly communicate with each other over one or more buses 840. The node 800 may be a UE or a BS that performs various functions disclosed with reference to FIGS. 1 through 7.

The transceiver 820 has a transmitter 822 (e.g., transmitting/transmission circuitry) and a receiver 824 (e.g., receiving/reception circuitry) and may be configured to transmit and/or receive time and/or frequency resource partitioning information. The transceiver 820 may be configured to transmit in different types of subframes and slots including, but not limited to, usable, non-usable and flexibly usable subframes and slot formats. The transceiver 820 may be configured to receive data and control channels.

The node 800 may include a variety of computer-readable media. Computer-readable media may be any available media that may be accessed by the node 800 and include both volatile (and non-volatile) media, and removable (and non-removable) media.

The computer-readable media may include computer-storage media and communication media. Computer-storage media may include both volatile (and/or non-volatile) media, and removable (and/or non-removable) media implemented in any method or technology for storage of information such as computer-readable instructions, data structures, program modules or data.

Computer-storage media may include RAM, ROM, EPROM, EEPROM, flash memory (or other memory technology), CD-ROM, Digital Versatile Disks (DVD)(or other optical disk storage), magnetic cassettes, magnetic tape, magnetic disk storage (or other magnetic storage devices), etc. Computer storage media may not include a propagated data signal. Communication media may typically embody computer-readable instructions, data structures, program modules or other data in a modulated data signal such as a carrier wave or other transport mechanisms and include any information delivery media.

The term “modulated data signal” may refer a signal that has one or more of its characteristics set or changed in such a manner as to encode information in the signal. Communication media may include wired media such as a wired network or direct-wired connection, and wireless media such as acoustic, RF, infrared and other wireless media. Combinations of any of the previously disclosed components should also be included within the scope of computer-readable media.

The memory 828 may include computer-storage media in the form of volatile and/or non-volatile memory. The memory 828 may be removable, non-removable, or a combination thereof. Example memory may include solid-state memory, hard drives, optical-disc drives, etc. As illustrated in FIG. 8, the memory 828 may store computer-readable and/or computer-executable instructions 832 (e.g., software codes) that are configured to, when executed, cause the processor 826 to perform various functions disclosed herein, for example, with reference to FIGS. 1 through 7. Alternatively, the instructions 832 may not be directly executable by the processor 826 but be configured to cause the node 800 (e.g., when compiled and executed) to perform various functions disclosed herein.

The processor 826 (e.g., having processing circuitry) may include an intelligent hardware device, e.g., a Central Processing Unit (CPU), a microcontroller, an ASIC, etc. The processor 826 may include memory. The processor 826 may process the data 830 and the instructions 832 received from the memory 828, and information transmitted and received via the transceiver 820, the base band communications module, and/or the network communications module. The processor 826 may also process information to provide to the transceiver 820 for transmission via the antenna 836 to the network communications module for transmission to a CN.

One or more presentation components 834 may present data indications to a person or another device. Examples of presentation components 834 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with reference to specific implementations, a person of ordinary skill in the art may recognize that changes may be made in form and detail without departing from the scope of those concepts. Therefore, the disclosed implementations are considered in all respects as illustrative and not restrictive. It should also be understood that the present disclosure is not limited to the specific disclosed implementations. Still, many rearrangements, modifications, and substitutions are possible without departing from the scope of the present disclosure.

1. A method for handling hybrid automatic repeat request (HARQ)-acknowledgment (ACK) feedback performed by a user equipment (UE), the method comprising:
receiving, from a base station (BS), a parameter for disabling a HARQ-ACK feedback for a HARQ process identifier (ID);
receiving, from the BS, downlink control information (DCI) for scheduling a physical downlink shared channel (PDSCH), the DCI indicating the HARQ process ID;
setting a HARQ-ACK bit associated with the HARQ process ID to a bit value representing a negative acknowledgment (NACK); and
transmitting, to the BS, a HARQ-ACK codebook including the HARQ-ACK bit.

2. The method of claim 1, wherein the parameter is received via radio resource control (RRC) signaling.

3. The method of claim 1, wherein the parameter includes a list of HARQ process IDs for indicating that HARQ-ACK feedbacks for the list of HARQ process IDs are disabled.

4. The method of claim 1, wherein the HARQ-ACK codebook is transmitted on a physical uplink control channel (PUCCH).

5. The method of claim 4, further comprising:
obtaining an adjusted number of HARQ-ACK bits by precluding the HARQ-ACK bit associated with the HARQ process ID; and
determining a transmission power for the PUCCH according to the adjusted number of HARQ-ACK bits.

6. The method of claim 1, further comprising:
receiving, from the BS, a timing offset used in a Non-Terrestrial Network (NTN), wherein the timing offset is associated with a time interval between the PDSCH and the transmission of the HARQ-ACK codebook.

7. The method of claim 6, further comprising:
determining one or more candidate PDSCH reception occasions corresponding to the HARQ-ACK codebook according to the timing offset.

8. The method of claim 6, further comprising:
receiving, from the BS, a k1 value that indicates a time difference between the PDSCH and the transmission of the HARQ-ACK codebook in a Terrestrial Network; and
obtaining the time interval between the PDSCH and the transmission of the HARQ-ACK codebook in the NTN by adding the k1 value with the timing offset.

9. A user equipment (UE) for handling hybrid automatic repeat request (HARQ)-acknowledgment (ACK) feedback, comprising:
at least one processor; and
at least one memory coupled to the at least one processor, wherein the at least one memory stores computer-executable instructions that, when executed by the at least one processor, cause the UE to:
receive, from a base station (BS), a parameter for disabling a HARQ-ACK feedback for a HARQ process identifier (ID);
receive, from the BS, downlink control information (DCI) for scheduling a physical downlink shared channel (PDSCH), the DCI indicating the HARQ process ID:
set a HARQ-ACK bit associated with the HARQ process ID to a bit value representing a negative acknowledgment (NACK); and
transmit, to the BS, a HARQ-ACK codebook including the HARQ-ACK bit.

10. The UE of claim 9, wherein the parameter is received via radio resource control (RRC) signaling.

11. The UE of claim 9, wherein the parameter includes a list of HARQ process IDs for indicating that HARQ-ACK feedbacks for the list of HARQ process IDs are disabled.

12. The UE of claim 9, wherein the HARQ-ACK codebook is transmitted on a physical uplink control channel (PUCCH).

13. The UE of claim 12, wherein the computer-executable instructions, when executed by the at least one processor, further cause the UE to:
obtain an adjusted number of HARQ-ACK bits by precluding the HARQ-ACK bit associated with the HARQ process ID; and
determine a transmission power for the PUCCH according to the adjusted number of HARQ-ACK bits.

14. The UE of claim 9, wherein the computer-executable instructions, when executed by the at least one processor, further cause the UE to:
receive, from the BS, a timing offset used in a Non-Terrestrial Network (NTN), wherein the timing offset is associated with a time interval between the PDSCH and the transmission of the HARQ-ACK codebook.

15. The UE of claim 14, wherein the computer-executable instructions, when executed by the at least one processor, further cause the UE to:
determine one or more candidate PDSCH reception occasions corresponding to the HARQ-ACK codebook according to the timing offset.

16. The UE of claim 14, wherein the computer-executable instructions, when executed by the at least one processor, further cause the UE to:
receive, from the BS, a k1 value that indicates a time difference between the PDSCH and the transmission of the HARQ-ACK codebook in a Terrestrial Network; and
obtain the time interval between the PDSCH and the transmission of the HARQ-ACK codebook in the NTN by adding the k1 value with the timing offset.
